(19) United States
(12) Patent Application Publication
(10) Pub. No.: US 2008/0238838 A1
(43) Pub. Date: Oct. 2, 2008

(54) Digital color controller

(76) Inventor: Jack Wayne Cunningham, Austin, TX (US)

Correspondence Address: PATRICK STELLITANO, 2803 INRIDGE DR., AUSTIN, TX, 78745, US

(21) Appl. No.: 11/732,106

(22) Filed: Apr. 2, 2007

(51) Int. Cl. G09G 3/32

(52) U.S. Cl. 345/83

(57) ABSTRACT

A digital color controller for illumination of dashboards and instrument panels is provided. In one embodiment, a digital color controller comprises a single control mechanism for varying the color of illumination of RGB LEDs. A microcontroller maps the signal derived from the control mechanism to an array of discrete color values. A selected discrete color value is passed to an LED driver to drive the LEDs to display the selected color.

### FIELD

The present invention is in the field of backlighting or illumination of dashboards and instrument panels.

### BRIEF DESCRIPTION OF THE DRAWINGS

Advantages of the invention will become apparent upon reading the following detailed description and upon reference to the accompanying drawings, in which like references may indicate similar elements:

FIG. 1 depicts a block diagram of an embodiment of a digital color controller.

FIG. 2 depicts a flow chart of an embodiment for single control variation of color of illumination.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed description below is designed to render various embodiments obvious to a person of ordinary skill in the art.

A digital color controller for illumination of dashboards and instrument panels is provided. In one embodiment, a digital color controller comprises a single control mechanism for varying the overall perceived color of illumination of Red-Green-Blue Light Emitting Diodes (RGB LEDs). A microcontroller maps the signal derived from the control mechanism to an array of discrete color values. A selected discrete color value is passed to an LED driver to drive the LEDs to display the selected color.

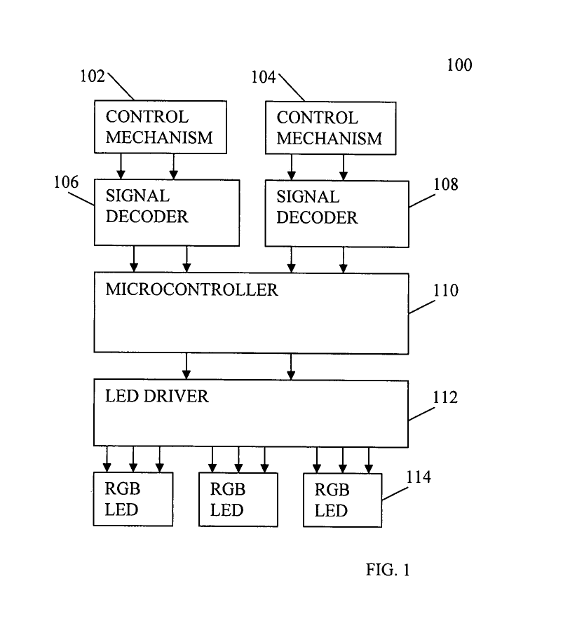

FIG. 1 is a block diagram of an embodiment 100 for enabling a user to adjust color of illumination of a dashboard or instrument panel using a single variable control. The embodiment provides one control mechanism 102 to adjust brightness and another control mechanism 104 to adjust color. In one embodiment, a control mechanism may be a rotary encoder which is digital to produce digital outputs indicative of the motion imparted to the rotary encoder. In another embodiment, the control mechanism is an analog device such as, for example, a potentiometer, to produce an analog signal indicative of a user desired brightness or color. In yet another embodiment, a control mechanism is a push button control, wherein each of a succession of depressions of the push button allows the user to individually select which one of red, green, or blue components of the RGB LED to adjust.

In the case of a digital rotary encoder, when the rotary encoder is turned counter-clockwise, a pulse from a first output leads a pulse from a second output of the rotary encoder. When the rotary encoder is turned clockwise, a pulse from the second output leads a pulse from the first output. The outputs therefore indicate the direction in which the rotary switch is turned. A clockwise turn of encoder 102 would increase brightness, whereas a counter-clockwise turn of encoder 102 would decrease brightness. Turning encoder 104 changes the perceived color emitted by Red-Green-Blue (RGB) Light Emitting Diodes (LED) which illuminate an instrument panel.

The output of control mechanism 102 is input to a signal decoder 106, and the output of control mechanism 104 is input to a signal decoder 108. Signal decoders 106 and 108 may be implemented as quadrature clock decoder integrated circuits such as, for example, an LS7184 from LSI Computer Systems. In one embodiment, signal decoders 106 and 108 may include signal conditioning circuitry to filter out spurious signals from the rotary encoders, such as may occur when a user initially starts to turn a rotary encoder or when the user stops turning the rotary encoder. Such signal conditioning circuitry is sometimes called de-bouncing circuitry and enables a smooth transition from one level of brightness to another or from one color to another. Each signal decoder provides a clock signal output that indicates that the user has turned the respective rotary encoder to which it is connected. Each decoder also provides an up/down signal output to indicate which direction the rotary encoder is turned. For example, a logic high might represent counter-clockwise rotation, whereas a logic low may indicate clockwise rotation.

A microcontroller 110 receives the clock signals and up/down signals from the decoders 106 and 108. An example of a microcontroller suitable for use in an embodiment is a PIC 16F87 from Microchip Technology, Inc. In another embodiment, the microcontroller may be a PIC18F2320. Note that in another embodiment, the functions of signal encoders 106 and 108 and the functions of microcontroller 110 may be combined in digital processing circuitry tailored to perform both sets of functions.

The clock signals from the decoders 106, 108 are routed to input ports of the microcontroller. These inputs are configured to interrupt the software executed by the microcontroller when the levels on the inputs change from logic high to logic low. The microcontroller executes a brightness adjust routine when the user turns the brightness rotary encoder 102, and the microcontroller executes a color adjust routine when the user turns the color rotary encoder 104. Within the brightness adjust software routine executed by microcontroller 110, the up/down signal from decoder 106 causes adjustment of a brightness index. Within the color adjust software routine executed by microcontroller 110, the up/down signal from decoder 108 causes adjustment of a color index.

In one embodiment, the color index value selects one of a group of red-green-blue combinations within a 15 by 3 array of color combinations. Since only one number for the color index is selectable at a time, the software maps each color index into a different specific red-green-blue combination chosen by the programmer. This enables the user to select among a variety of colors using a single control. Thus, a particular color index is mapped to a particular red-green-blue combination which results in a specific color perceived by the user. Microcontroller 110 outputs a color signal, comprising, for each color, an address to select the color and an intensity index for the addressed color.

The color signal, comprising the address and color intensity index for each color of the selected RGB combination, is sent to and received by an LED driver integrated circuit 112. Also sent to the LED driver integrated circuit 112 is a brightness signal corresponding to the brightness index generated by the brightness adjust software routine executed by microcontroller 110. In one embodiment, the LED driver integrated circuit is a device such as a MAX6964 from Maxim Integrated Products, Inc., connected to the microcontroller through an I2C (inter-integrated circuit) two wire interface. In another embodiment, the LED driver integrated circuit is a device such as a MAX6966 connected to the microcontroller through a three-wire PCI (Peripheral Control Interface).

LED driver integrated circuit 112 receives the brightness and color signals from the microcontroller and outputs appropriate pulse-width modulated signals to drive LEDs 114. For instance, the brightness signal causes pulse-width modulated signals to be output to separately drive each of the three components (red-green-blue) of an LED, the duty cycle of the pulse being proportional to the magnitude of the brightness signal. Within the brightness-defined duty cycle the color index of the color signal controls a pulse width of the pulse-width modulated signal separately for each of the red, green and blue components of the LED.

Thus, one embodiment comprises an instrument panel illumination apparatus for adjusting the color of the illumination of an instrument panel using a single user control for color variation. The apparatus comprises a control mechanism to vary an overall perceived color of illumination of the panel. A signal encoder produces a digital signal indicative of a movement of the control mechanism. The signal encoder may comprise de-bouncing circuitry to filter out undesirable spurious signals from the first control mechanism. A microcontroller receives the digital signal and responsively produces a color signal. The color signal is indicative of a particular selected red-green-blue color combination among a plurality of red-green-blue color combinations. An LED driver receives the color signal and responsively produces pulse-width modulated signals to drive at least one RGB LED to produce the selected color. At least one RGB LED capable of emitting a combination of red-green-blue color in response to the pulse-width modulated signals from the LED driver produces the selected color.

Further, embodiments may comprise a second control mechanism to adjust a brightness level of the LEDs. The brightness adjustment results in a brightness signal to the LED driver to adjust a pulse-width modulated output from the LED driver to affect the overall perceived brightness of each red, green and blue component of the at least one LED. The brightness signal is addressed to a brightness register in the LED driver. The brightness signal causes the LED driver to adjust the brightness by proportionally increasing or decreasing the pulse width of signals to the red, green and blue components of the LED.

In yet another embodiment, a push button control is provided to enable the user to individually vary the illumination of each red, green, or blue component of the at least one RGB LED. This embodiment incorporates a push button controller and a digital counter circuit. Successive depressions of the push button will increment the counter, for example, from zero to three and then the counter will reset. (Alternative to the use of a push button is a four position rotary switch.) When the color interrupt function executed by the microcontroller is active, the microcontroller reads the levels from the counter to determine which of four modes of operation is selected by the user by way of the push-button control. These four modes of operation may, in one embodiment, comprise (1) adjust red only; (2) adjust green only; (3) adjust blue only; or (4) adjust overall color. Thus, the user is able to adjust each color individually to select a larger number of combinations of overall perceived colors.

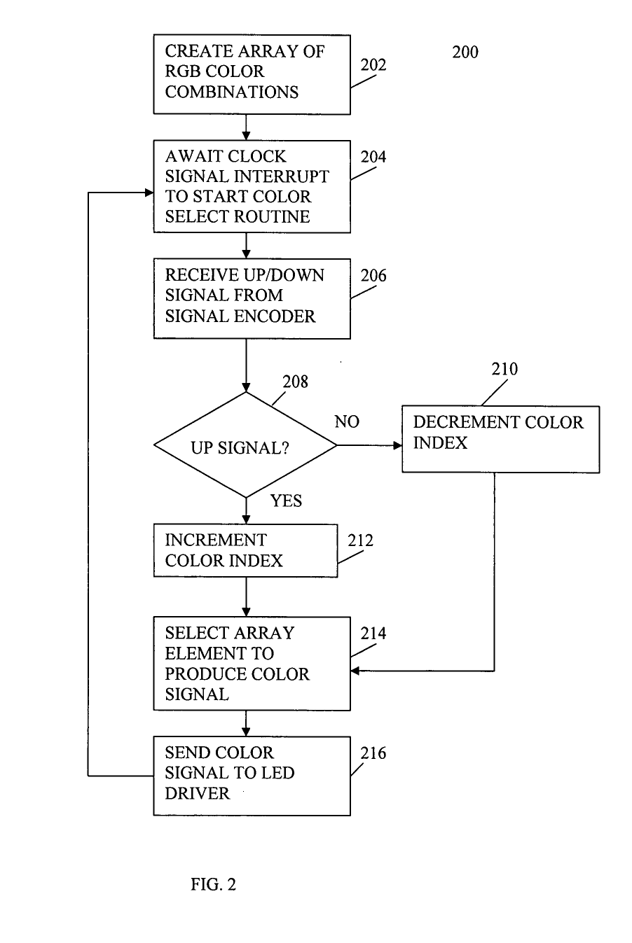

FIG. 2 shows a simplified flow chart 200 of a computer program executable by microcontroller 110 to vary a color displayed by one or more RGB LEDs. When the computer program initiates, a beginning step creates an array representative of a plurality of red-green-blue combinations for producing a variety of colors (element 202). In one embodiment, the array may comprise the following:
(0, 238, 0), (136, 238, 0), (238, 238, 0),
(238, 136, 0), (238, 68, 0), (238, 0, 0),
(138, 0, 68), (238, 0, 238), (138, 0, 238),
(0, 0, 238), (0, 136, 238), (0, 238, 238),
(68, 136, 187), (136, 238, 187), (238, 238, 238)
   Thus, in this embodiment, there are 15 different color values that can be selected for display by the LEDs. Persons of ordinary skill in the art will recognize that other color levels can be implemented.

After the color array is defined, the software program may remain in an idle state until a color signal interrupt is received from signal encoder 108 (element 204). When the clock signal interrupt is received, microcontroller 110 receives the up or down signal from the encoder 108 (element 206). The microcontroller then determines if the signal is “up” corresponding to turning the rotary encoder 104 clockwise, or whether the signal is “down” corresponding to turning the rotary encoder counter-clockwise. If an up signal, then a color index is incremented (element 212). If a down signal, then the color index is decremented (element 210). Also, not shown in FIG. 2, is logic to prevent the color index from exceeding a maximum value or declining below zero. Once the color index is determined, it is used as an index into the color array shown above to select one of the 15 color values (element 214). This color value is sent to the LED driver to drive the LEDs to exhibit the selected color (element 216). The system then awaits the next color clock signal interrupt (element 204).

Thus, another embodiment is a method for producing an illumination of an instrument panel using a single control to vary the color of illumination of a dashboard or instrument panel, such as may be found, for example, in a motor vehicle. The method comprises providing a single control to enable a user to vary a color of illumination, the single control providing a signal indicative of a movement of the control. The method further comprises deriving from the signal from the control a color signal comprising addresses of a red, blue, and green component of an LED, and for each address, producing a color intensity level. The method also comprises driving each color component of the LED with a pulse-width modulated signal, the width of a pulse determined by the color intensity level for the component. In some embodiments, the method also comprises providing a second control to simultaneously adjust the brightness of the LED red, blue, and green components. The method may also comprise deriving a color signal from the control signal by mapping a number proportional to the control signal to one of a plurality of sets of red, green and blue intensity levels. The method may further comprise filtering out undesirable spurious signals.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An instrument panel illumination apparatus for adjusting the color of the illumination of an instrument panel using a single user control for color variation, comprising:
a first control mechanism to vary a color of illumination of the panel;
a signal encoder to produce a digital signal indicative of a movement of the control mechanism;
a microcontroller to receive the digital signal and to responsively produce a color signal, the color signal indicative of a particular selected red-green-blue color combination among a plurality of red-green-blue color combinations as selected by the first control mechanism;
a Light Emitting Diode (LED) driver to receive the color signal and to responsively produce pulse-width modulated signals to drive at least one Red-Green-Blue (RGB) LED to produce the selected color; and
at least one RGB LED capable of emitting a combination of red-green-blue color in response to the pulse-width modulated signals from the LED driver to produce the selected color.

2. The apparatus of claim 1, further comprising a second control mechanism to adjust a brightness level of the LEDs.

3. The apparatus of claim 2, wherein the brightness adjustment results in a brightness signal to the LED driver to adjust a pulse-width modulated output from the LED driver to simultaneously affect the brightness of each red, green and blue component of the at least one LED.

4. The apparatus of claim 1, wherein the microcontroller outputs a color signal comprising an address of a red, green or blue component of an LED and an intensity for the addressed color.

5. The apparatus of claim 4, wherein the intensity component of the color signal affects the width of a pulse-width modulated pulse output of the LED driver.

6. The apparatus of claim 1, wherein the microcontroller maps a plurality of numeric levels to a plurality of corresponding red-green-blue intensity combinations.

7. The apparatus of claim 1, wherein the signal encoder comprises de-bouncing circuitry to filter out undesirable spurious signals from the first control mechanism.

8. The apparatus of claim 1, wherein the first control mechanism is a rotary encoder.

9. The apparatus of claim 1, wherein a second control mechanism enables a user to select whether to adjust the red, green, or blue color to be individually adjusted by way of the first control mechanism.

10. A method for producing an illumination of an instrument panel using a single control to vary the color of illumination, comprising:
providing a single control to enable a user to vary a color of illumination, the single control providing a signal indicative of a movement of the control;
deriving from the signal from the control a color signal comprising addresses of a red, blue, and green component of a Light Emitting Diode (LED) and for each address a color intensity level; and
driving each component of the LED with a pulse-width modulated signal, the width of a pulse determined by the color intensity level for the component.

11. The method of claim 10, further comprising providing a second control to simultaneously adjust the brightness of the LED red, blue, and green components.

12. The method of claim 10, wherein deriving a color signal from the control signal comprises mapping a number proportional to the control signal to one of a plurality of sets of red, green and blue intensity levels.

13. The method of claim 10, wherein providing a single control further comprises providing a rotary encoder.

14. The method of claim 10, wherein deriving a color signal from the control signal further comprises filtering out undesirable spurious signals.

15. The method of claim 10, further comprising providing a second control mechanism to select which one of the red, green, or blue colors to be individually adjusted by a user.

16. A digital color controller, enabling a user to vary color of an illumination of an instrument panel using a single color control, comprising:
a first control mechanism to vary a color of illumination of the panel by producing an electrical signal responsive to a movement of the control;
a digital processing circuitry responsive to the electrical signal to produce a color signal, the color signal indicative of a particular selected red-green-blue color combination among a plurality of red-green-blue color combinations as selected by the first control mechanism;
a Light Emitting Diode (LED) driver to receive the color signal and to responsively produce pulse-width modulated signals to drive red, green and blue components of at least one Red-Green-Blue (RGB) LED to produce the selected color; and
at least one RGB LED capable of emitting a combination of red-green-blue color in response to the pulse-width modulated signals from the LED driver to produce the selected color.

17. The digital color controller of claim 16, further comprising circuitry to filter spurious signals from the first control mechanism.

18. The digital color controller of claim 16, wherein the digital processing circuitry determines a color index from the electrical signal and maps the index to one of a plurality of sets of red-green-blue color combinations.

19. The digital color controller of claim 16, wherein the first control mechanism is an analog rotary device and analog to digital conversion circuitry is provided to convert the analog signal from the analog rotary device to a digital signal.

20. The digital color controller of claim 16, further comprising a second control mechanism to produce a brightness signal received by the digital processing circuitry to control the LED driver to modulate a pulse-width modulated signal to control brightness of the at least one LED.
